(19) United States
(12) Patent Application Publication
(10) Pub. No.: US 2008/0211660 A1
(43) Pub. Date: Sep. 4, 2008

(54) Field device system and field device system diagnosing method

(75) Inventor: Makoto Takeuchi, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/983,511

(22) Filed: Nov. 9, 2007

(30) Foreign Application Priority Data
Nov. 9, 2006 (JP) 2006-303663
Dec. 11, 2006 (JP) 2006-332909

(51) Int. Cl. G08B 29/06

(52) U.S. Cl. 340/514

(57) ABSTRACT

A field device system having a transmission line, includes a diagnostic module that detects whether or not a failure of the transmission line is present.

Also, the diagnostic module has at least one measuring portion for measuring electric characteristics of the transmission line, and the like.

### TECHNICAL FIELD

The present disclosure relates to a field device system connected to a transmission line and, more particularly, to detect and diagnose a failure such as short-circuit of the transmission line, or the like.

Also, the present disclosure relates to a failure diagnosis of a field device system and, more particularly, a field device system and a method of diagnosing the same for improving reliability of communication, etc. in the field device system against a failure such as open circuit, short circuit, or the like of the transmission line.

### RELATED ART

For example, in the plant instrumentation, the system in which the host unit and the field devices are connected via the transmission lines is often employed. Such system is exposed to the weather in open-air use. Thus, rainwater, and the like soak into the inside of the field device, and sometimes the terminal portions are submerged to cause the short circuit between terminal portions.

A configuration of an ordinary field device system 12 in the related art is shown in FIG. 20. Transmission lines 1, 2 are connected to a common DC power supply 3. As the standard of the field device system 12, there are FOUNDATION FIELDBUS, PROFIBUS, HART, and the like.

A pair of terminators 4, 5 are connected to both end portions of the transmission lines 1, 2. A host unit 6 for holding communication via the transmission line is connected to the transmission lines 1, 2.

Also, a differential pressure transmitter 9 as one of the field devices is connected to transmission line 7, 8 that are branched off from the transmission line 1, 2. Similarly, a temperature transmitter 10 and a vortex flowmeter 11 as the field device are connected to transmission line 7, 8 that are branched off from the transmission line 1, 2. In addition, there are an electromagnetic flowmeter, a Coriolis mass flowmeter, an ultrasonic flowmeter, a level meter, and the like as the field device.

The transmission lines 7, 8 are connected to independent terminal portions (not shown) in the field device through a wiring port (not shown) of the field device such as the differential pressure transmitter 9. Then, the packing is provided to the wiring port such that the rainwater, and the like do not soak into the inside of the field device through the wiring port.

In such connection configuration, one of plural field devices such as the differential pressure transmitter 9, and the like is selected periodically or in response to a command from the host unit 6, and then communication is held between the host unit 6 and the selected field device by means of an AC modulation of its current consumption.

In contrast, the field device such as the differential pressure transmitter 9, or the like converts a physical quantity such as a differential pressure/pressure, a flow rate, or the like in an electric signal to calculate a differential pressure/pressure value, a flow rate value, or the like. The field device converts the calculated value to the AC modulated signal and transmits it to the host unit 6, and the host unit 6 controls the physical quantity.

The current consumption is designed to 4-20 mA, for example, and a span of a variable portion 0-16 mA is AC-modulated in a range of ±8 mA with respect to 8 mA. Also, when a load resistance between the transmission lines 1, 2 is designed to 50 Ω, an AC voltage of ±400 mV is generated between the transmission lines 1, 2 and the host unit 6 receives this AC voltage. A 0.75 to 1 Vp-p signal as the communication signal is superposed on the voltage between the transmission lines 1, 2 on the FOUNDATION FIELDBUS.

In this case, an outline of the configuration of the ordinary field device system in such related art is set forth in FIG. 2 of Patent Literature 1.

Also, a configuration of an ordinary field device system 19 in the related art is shown in FIG. 21. In FIG. 21, the same symbols are affixed to the same elements as those in FIG. 20 and their explanation will be omitted herein.

The field device such as the differential pressure transmitter 9, or the like is connected to the transmission lines 1, 2 via the transmission lines 7, 8, a multiple device connecting device 15, and transmission lines 13, 14.

More specifically, the multiple device connecting device 15 is connected to the transmission lines 13, 14 branched off from the transmission lines 1, 2. One side of a connection terminal 16 in the multiple device connecting device 15 is connected to the transmission lines 13, 14, and the other side is connected to the transmission lines 7, 8. The differential pressure transmitter 9 is connected to the transmission lines 7, 8. Similarly, connection terminals 17, 18 are connected to the temperature transmitter 10 and the vortex flowmeter 11 via the transmission lines respectively.

In such connection configuration, the host unit 6 communicates with a plurality of field devices such as the differential pressure transmitter 9, and the like and controls a physical quantity.

[Patent Literature 1] Japanese Patent Unexamined Publication No. 2004-86405

However, in FIG. 20 and FIG. 21, when no packing is adequately provided to the wiring port, the rainwater, and the like soak into the inside of the field device, and sometimes the terminal portions are submerged.

When the terminal portions are submerged, the electrolysis of water is caused by a voltage applied to the terminal portions and thus sometimes a dangerous gas such as hydrogen, or the like is generated from the terminal portions. Also, a metal of the terminal portions is ionized by the electrolysis and dissolved into the water. Therefore, an electric conductivity of the water is increased, and thus sometimes a leakage current flows between the independent terminal portions. Also, when a leakage current is further increased, in some cases the short circuit occurs between the terminal portions.

A transmission line current flowing through the transmission lines 1, 2, 7, 8 is increased due to an increase of the leakage current, and such an abnormality of the transmission lines 1, 2, 7, 8 occurs that an output voltage of the DC power supply 3 is lowered. Therefore, such communication interference is caused that the host unit 6 cannot communicate with a plurality of field devices.

In contrast, in FIG. 21, although the leakage current is increased similarly, a current restricting function of the multiple device connecting device 15 restricts the transmission line current flowing through the transmission lines 7, 8. Therefore, the output voltage of the DC power supply 3 is not lowered and occurrence of the communication interference can be prevented.

However, depending on components of the rainwater or a submerged condition, an increase and a decrease of the leakage current are generated repeatedly under the restricted current value of the multiple device connecting device 15. Thus, such an abnormality occurs that a noise superposes on the transmission lines 1, 2, 13, 14, 7, 8. Therefore, such communication interference occurs that the host unit 6 cannot communicate with a plurality of field devices.

In addition, a configuration of an ordinary field device system 154 in the related art is shown in FIG. 22. As the communication standard of the field device system, there are FOUNDATION FIELDBUS, PROFIBUS, HART, and the like.

A common DC power supply 103 is connected to transmission lines 101, 102. A pair of terminators 104, 105 are connected to both end portions of the transmission lines 101, 102 respectively. A host unit 106 for holding communication via the transmission line is connected to the transmission lines 101, 102.

Also, linking devices 144, 149 are connected to the transmission lines branched off from the transmission lines 101, 102. A differential pressure transmitter 145, a temperature transmitter 146, and a vortex flowmeter 147 as the field device are connected to the linking device 144 via the transmission line. Similarly, a differential pressure transmitter 150, a temperature transmitter 151, and a vortex flowmeter 152 are connected to the linking device 149 via the transmission line. In addition, there are an electromagnetic flowmeter, a Coriolis mass flowmeter, an ultrasonic flowmeter, a level meter, and the like as the field device.

The similar field device system is recited in FIG. 1 of Patent Literature 2, and an operation of the system will be explained hereunder (see Patent Literature 2).

The transmission line may be disconnected inadvertently, and is brought into the open circuit state. Also, the insulation degradation may occur because of the influence of the surrounding environment, and the transmission line is brought into the short circuit state.

When such abnormality of the transmission line occurs, the communication interference may be caused. In this case, in Patent Literature 2, the wiring failure detecting portion and the wiring failure diagnosing manager (not shown) for detecting/diagnosing the failure such as the open circuit, the short circuit, or the like of the transmission line as the cause of the communication interference and notifying the user of the type of failure is provided.

The wiring failure detecting portion has an ohmmeter, a voltmeter, a noise meter, and the like (see FIG. 3 of Patent Literature 2). This wiring failure detecting portion measures a resistance between a pair of transmission lines, a DC voltage, a noise level on the transmission line, and the like, and transmits these measured values to the wiring failure diagnosing manager. The wiring failure diagnosing manager compares the measured value with a predetermined threshold, decides that any failure of the transmission line occurs when the measured value is larger or smaller than the threshold, and notifies the user of the type of failure (see FIG. 4A, FIG. 4B, FIG. 5 of Patent Literature 2).

The wiring failure detecting portion and the wiring failure diagnosing manager are provided to the linking device 144. According to the notification, the user can know generation of the failure of the transmission line in a particular segment 148 and the type of the failure. Therefore, such user can remove the cause of the failure not to investigate the transmission line of other segment 153, and can overcome the communication interference.

[Patent Literature 2] Japanese Patent Unexamined Publication No. 2003-44133

However, the user can know the failure of the transmission line based on the above operation of the wiring failure detecting portion and the wiring failure diagnosing manager only after such failure is caused. Therefore, in some cases it is difficult to improve reliability of measurement, communication, control, etc. in a field device system 154 by predicting in advance occurrence of the failure and preventing occurrence of the communication interference.

Also, in some cases the communication interference may occur because the failure or the malfunction arises in the field device such as the differential pressure transmitter 145, the host unit 106, or the like. For example, sometimes the resistance between a pair of transmission lines, the DC voltage, the noise level on the transmission line, and the like do not exceed the threshold in the situation that performances of the components (not shown) of the communication circuit in the field device being not directly connected to the transmission line are degraded and thus the communication interference occurs. At this time, the wiring failure detecting portion and the wiring failure diagnosing manager cannot notify the user of the failure of the transmission line, and thus the user cannot know the cause of the communication interference. As a result, sometimes a huge amount of man-hour in investigating the cause is required.

In addition, for example, the transmission line is short-circuited inadvertently at the terminal portions (not shown) of the field device such as the differential pressure transmitter 145 connected to the transmission line. At this time, unless the user do remove the short circuit after the wiring failure detecting portion and the wiring failure diagnosing manager notified the user of the failure of the transmission line, the communication interference is still continued and the user cannot recover the communication function of the field device system 154.

### SUMMARY

Exemplary embodiments of the present invention provide a field device system equipped with a diagnostic module that detects an increase of a transmission line current due to an increase of a leakage current flowing though terminals portions when a terminal portion of a field device is submerged, and detects a failure of a transmission line due to a reduction of an output voltage of a DC power supply or superposition of noises.

Also, Exemplary embodiments of the present invention provide a field device system and a method of diagnosing the same capable of predicting in advance generation of a failure such as open circuit, short circuit, or the like of the transmission line, preventing occurrence of the communication interference, and improving reliability of measurement, communication, control, etc. in the field device system.

According to a first aspect of the present invention, there is provided a field device system having a transmission line, which includes a diagnostic module for detecting whether or not a failure of the transmission line is present.

According to a second aspect of the present invention, in the field device system according to the first aspect, the diagnostic module has a current measuring portion for measuring a transmission line current, a threshold calculating portion for calculating a threshold based on an initial measured value of the current measuring portion, a comparing portion for comparing a measured value of the current measuring portion with the threshold, and an alarm outputting portion for outputting an alarm based on an output of the comparing portion.

According to a third aspect of the present invention, in the field device system according to the second aspect, the diagnostic module further has a communicating portion for communicating information.

According to a fourth aspect of the present invention, in the field device system according to the second or third aspect, the diagnostic module further has a storing portion for storing the measured value of the current measuring portion together with time information.

According to a fifth aspect of the present invention, in the field device system according to any one of the second to fourth aspects, the diagnostic module is connected to the transmission line to which the field device is connected.

According to a sixth aspect of the present invention, in the field device system according to the fifth aspect, the field device system further has a switching portion for connecting or disconnecting the transmission line based on an alarm output of the diagnostic module.

According to the present invention, the field device system equipped with a diagnostic module that detects an increase of a transmission line current due to an increase of a leakage current flowing though terminals portions when a terminal portion of a field device is submerged, and detects a failure of a transmission line due to a reduction of an output voltage of a DC power supply or superposition of noises can be implemented.

According to a seventh aspect of the present invention, in the field device system according to the first aspect, the diagnostic module has at least one measuring portion for measuring electric characteristics of the transmission line, a threshold calculating portion for calculating a threshold based on an initial measured value of the measuring portion, a comparing portion for comparing a measured value of the measuring portion with the threshold, an alarm outputting portion for outputting an alarm based on an output of the comparing portion, a storing portion for storing the measured value of the measuring portion together with time information, and a communicating portion for holding communication with an external device.

According to an eighth aspect of the present invention, in the field device system according to the seventh aspect, the diagnostic module further has a predicting portion for predicting that a present measured value reaches the threshold after a predetermined time has elapsed, based on the measured value stored in the storing portion in a past and time information.

According to a ninth aspect of the present invention, in the field device system according to the seventh or eighth aspect, the diagnostic module further has a communication analyzing portion for calculating a number of time or a rate of a communication error of a field device.

According to a tenth aspect of the present invention, in the field device system according to any one of the seventh to ninth aspects, the diagnostic module is connected to the transmission line to which one of field devices is connected, and further has a switching portion for connection or disconnecting the transmission line based on the alarm output.

According to an eleventh aspect of the present invention, there is provided a diagnostic method of detecting a failure of a transmission line constituting a field device system, which includes a step of measuring electric characteristics of the transmission line by a measuring portion; a step of calculating a threshold based on an initial measured value of the measuring portion; a step of comparing a measured value of the measuring portion with the threshold; a step of outputting an alarm based on a compared result; a step of storing the measured value of the measuring portion together with time information; and a step of holding communication with an external device.

According to a twelfth aspect of the present invention, the diagnostic method according to the eleventh aspect further includes a step of predicting that a present measured value reaches the threshold after a predetermined time has elapsed, based on the measured value stored in the storing portion in a past and time information.

According to a thirteenth aspect of the present invention, the diagnostic method according to the eleventh or twelfth aspect further includes a step of calculating a number of time or a rate of a communication error of a field device.

According to the present invention, the field device system and the method of diagnosing the same, capable of predicting in advance occurrence of the failure such as open circuit, short circuit, or the like of the transmission line in the failure diagnosis of the field device system, preventing occurrence of the communication interference, and improving reliability of measurement, communication, control, etc. in the field device system can be implemented.

Other features and advantages may be apparent from the following detailed description, the accompanying drawings and the claims.

### BRIEF DESCRIPTION OF THE DRAWINGS

FIG. 1 is a configurative view showing an embodiment of the present invention;

FIG. 2 is a configurative view showing another embodiment of the present invention;

FIG. 3 is a block diagram showing a concrete example of a diagnostic module 20;

FIG. 4 is a block diagram, showing another concrete example of the diagnostic module 20;

FIG. 5 is a block diagram showing still another concrete example of the diagnostic module 20;

FIG. 6 is a configurative view showing another embodiment of the present invention;

FIG. 7 is a configurative view showing still another embodiment of the present invention;

FIG. 8 is a configurative view showing yet still another embodiment of the present invention;

FIG. 9 is a flowchart showing an operation of the diagnostic module 20;

FIG. 10 is a view showing a characteristic example of a transmission line current to a time when a terminal portion of a differential pressure transmitter is submerged;

FIG. 11 is a configurative view showing further embodiment of the present invention;

FIG. 12 is a block diagram showing a concrete example of a diagnostic module 120;

FIG. 13 is a block diagram showing another concrete example of the diagnostic module 120;

FIG. 14 is a block diagram showing still another concrete example of the diagnostic module 120;

FIG. 15 is a configurative view showing still further embodiment of the present invention;

FIG. 16 is a flowchart showing an operation of the diagnostic module 120;

FIG. 17 is a flowchart showing a predicting portion out of the operation of the diagnostic module 120;

FIG. 18 is a flowchart showing a communication analyzing portion out of the operation of the diagnostic module 120;

FIG. 19 is a view showing a characteristic example of a transmission line current to a time influenced by the surrounding environment;

FIG. 20 is a configurative view showing an example of the related art;

FIG. 21 is a configurative view showing another example of the related art; and

FIG. 22 is a configurative view showing still another example of the related art.

### DETAILED DESCRIPTION

### First Embodiment

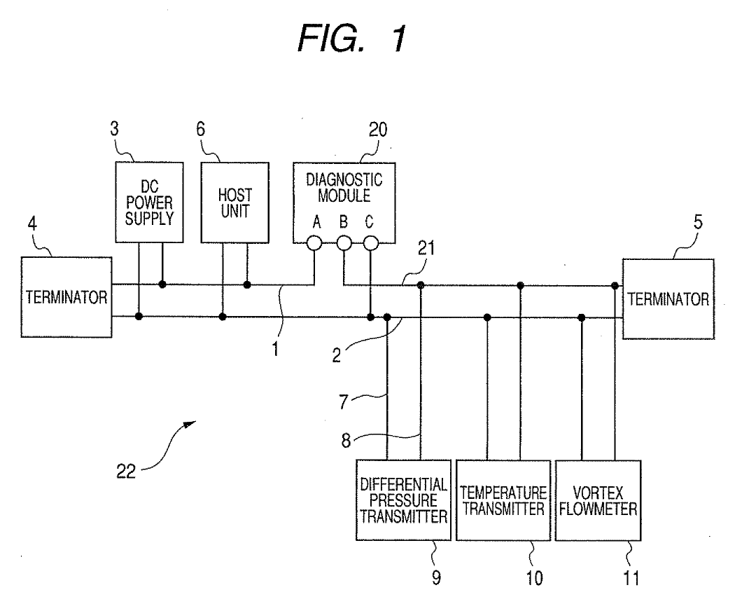

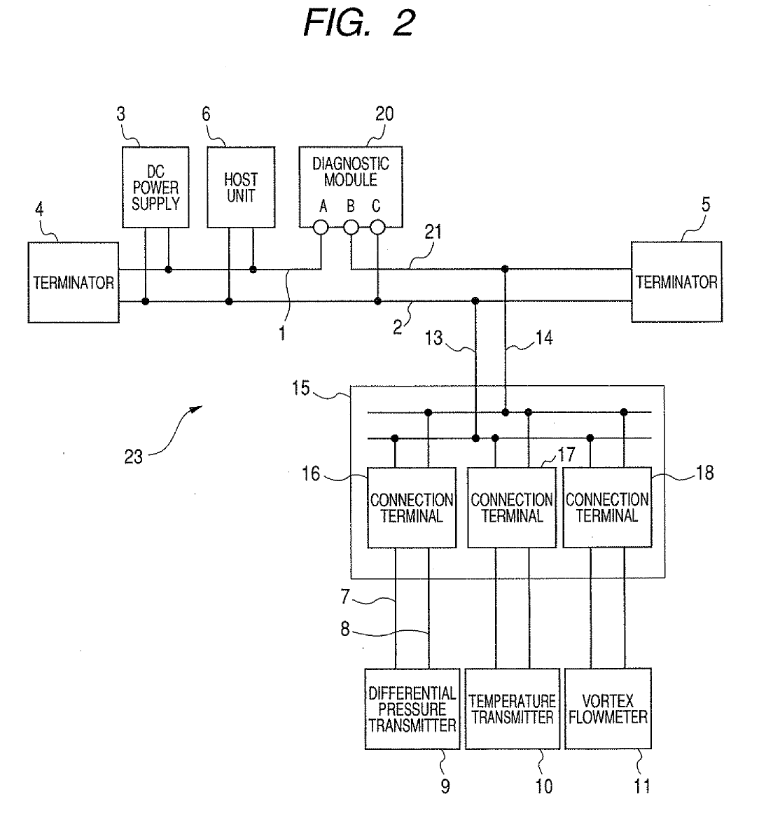

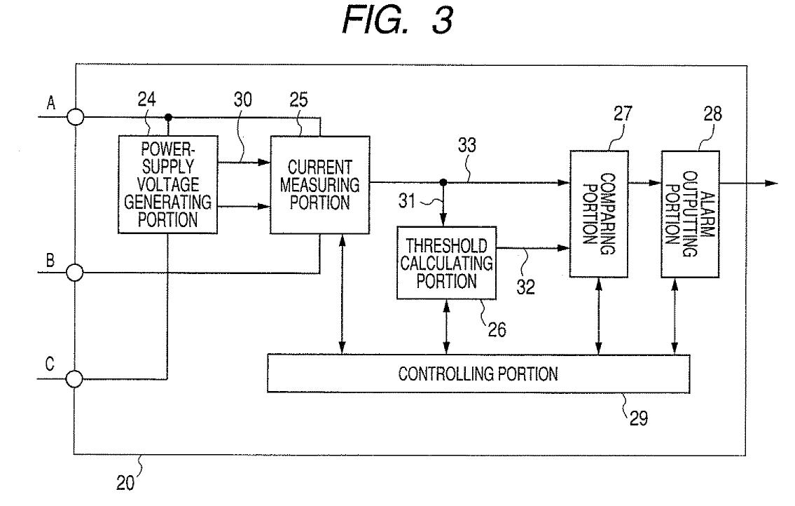

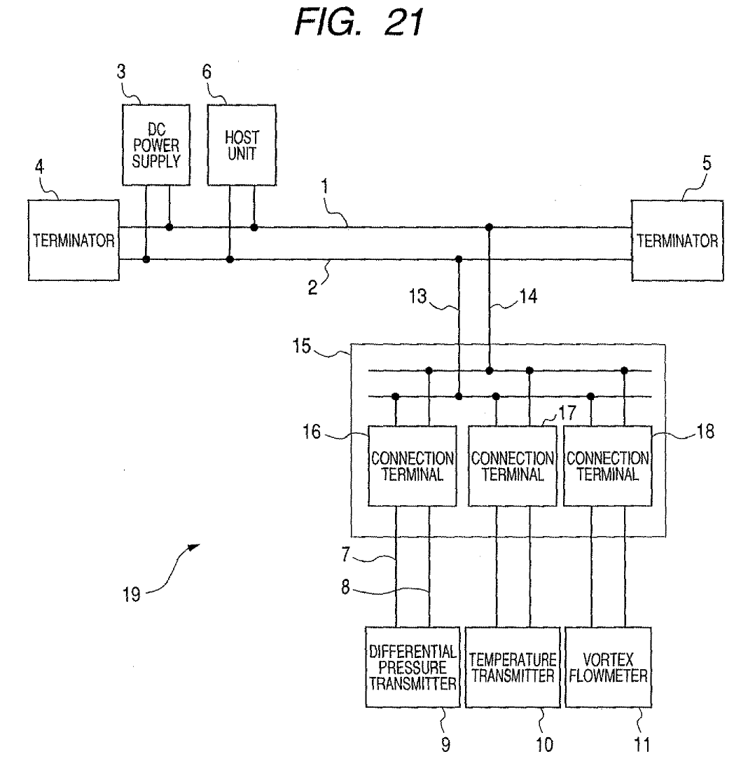

A first embodiment will be explained with reference to FIG. 1 to FIG. 3 hereunder. FIG. 1 is a field device system 22 showing a first embodiment of the present invention, and the same symbols are affixed to the same elements as those in FIG. 20 and their explanation will be omitted herein. FIG. 2 shows a field device system 23 when the multiple device connecting device 15 is employed in FIG. 1, and the same symbols are affixed to the same elements as those in FIG. 1 and FIG. 21 and their explanation will be omitted herein. FIG. 3 is a block diagram of a diagnostic module 20.

Then, explanation will be made on the assumption that the terminal portions of the differential pressure transmitter 9 are submerged.

In order to measure the transmission line current flowing through a plurality of field devices such as the differential pressure transmitter 9, the diagnostic module 20 is connected to the transmission lines 1, 2 connected between the DC power supply 3 and a plurality of field devices.

More specifically, a terminal A of the diagnostic module 20 is connected to the transmission line 1, a terminal B is connected to a transmission line 21, and a terminal C is connected to the transmission line 2. The terminator 5 is connected to the transmission lines 21, 2, and the differential pressure transmitter 9 as one of field devices is connected to the transmission lines 7, 8 branched off from the transmission lines 21, 2. Similarly, the temperature transmitter 10 and the vortex flowmeter 11 as the field devices are connected to the transmission lines branched off from the transmission lines 21, 2.

The diagnostic module 20 is composed of a power-supply voltage generating portion 24, a current measuring portion 25, a threshold calculating portion 26, a comparing portion 27, an alarm outputting portion 28, and a controlling portion 29.

The power-supply voltage generating portion 24 is connected to the terminal A and the terminal C, and generates an internal power-supply voltage 30 from the output voltage of the DC power supply 3. Then, the power-supply voltage generating portion 24 supplies this voltage to respective portions such as the current measuring portion 25, and the like.

The current measuring portion 25 is connected to the terminal A and the terminal B, and measures currents fed to a plurality of field devices such as differential pressure transmitter 9, etc. through the transmission lines 1, 21, 2.

The threshold calculating portion 26 calculates a threshold 32 based on an initial measured value 31 of the current measuring portion 25. The comparing portion 27 compares a threshold 32 with a measured value 33 of the current measuring portion 25. The alarm outputting portion 28 outputs an alarm based on an output of the comparing portion 27. An output of the alarm outputting portion 28 is connected to an acoustic device such as a buzzer, a lamp, or the like and an illumination device (not shown).

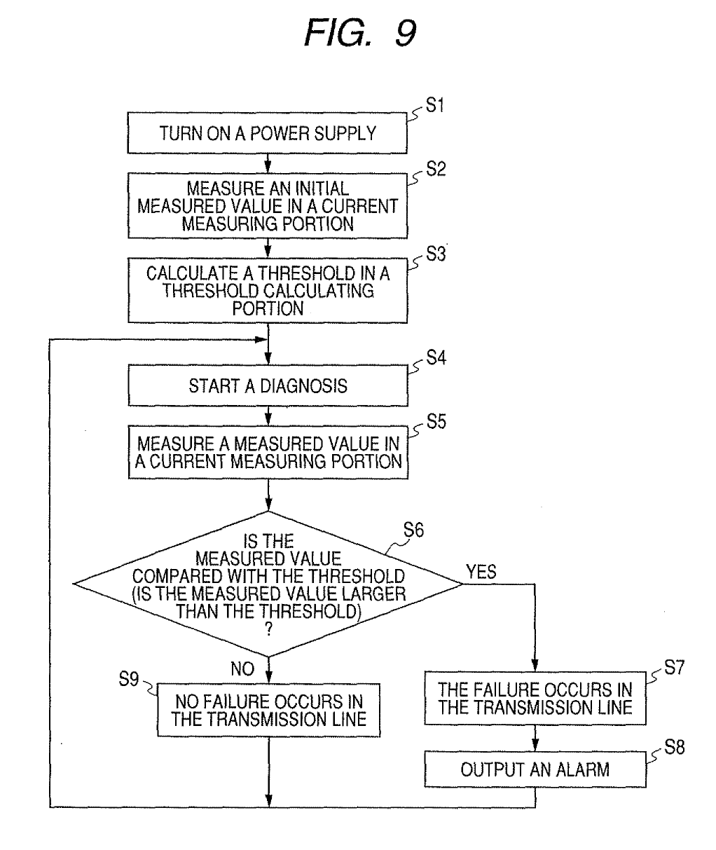

An operation of the diagnostic module 20 will be explained with reference to a flowchart in FIG. 9 hereunder.

When the DC power supply 3 outputs a voltage, this voltage is applied to the terminal A and the terminal C of the diagnostic module 20 (step S1). Then, the diagnostic module 20 executes step S2 et seq.

The measured value of the current measuring portion 25 is input in the threshold calculating portion 26 as the initial measured value 31 (step S2). The initial measured value 31 is the current of the transmission lines 1, 21, 2 flowing through a plurality of field device systems such as the differential pressure transmitter 9, and the like when the transmission lines are in the normal condition.

The threshold calculating portion 26 adds a variation of the current of the transmission lines 1, 21, 2 flowing through the field device systems such as the differential pressure transmitter 9, etc. when the transmission lines are in the normal condition to the initial measured value 31, and thus calculates the threshold 32 to detect the abnormality of the transmission line (step S3). The threshold 32 is input into the comparing portion 27. Because the threshold 32 is different dependent on a variation of the current of the field devices such as the differential pressure transmitter 9, etc. and the configurations of their terminal portions, such threshold 32 may be changed and set.

Then, the diagnostic module 20 starts the failure diagnosis of the transmission line (step S4). The measured value 33 of the current measuring portion 25 is input into the comparing portion 27 (step S5). The comparing portion 27 compares the measured value 33 with the threshold 32 (step S6). If the measured value 33 is larger than the threshold 32, the diagnostic module 20 detects that the abnormality occurs in the transmission line (step S7).

In order to notify the user that the abnormality occurs in the transmission line, the alarm outputting portion 28 output a sound from an acoustic device such as a buzzer, or the like or outputs an alarm signal to lighten or flash an illumination device such as a lamp, or the like (step S8).

Also, if the measured value 33 is smaller than the threshold 32, the diagnostic module 20 detects that no abnormality occurs in the transmission line (step S9). The alarm outputting portion 28 does not output the alarm signal. Subsequently, processes in step S4 et seq. are repeated.

The controlling portion 29 controls respective portions such as the comparing portion 27, etc. and executes the processes based on a flowchart shown in FIG. 9. The controlling portion 29 including the comparing portion 27, etc. can be implemented by the microprocessor (MPU).

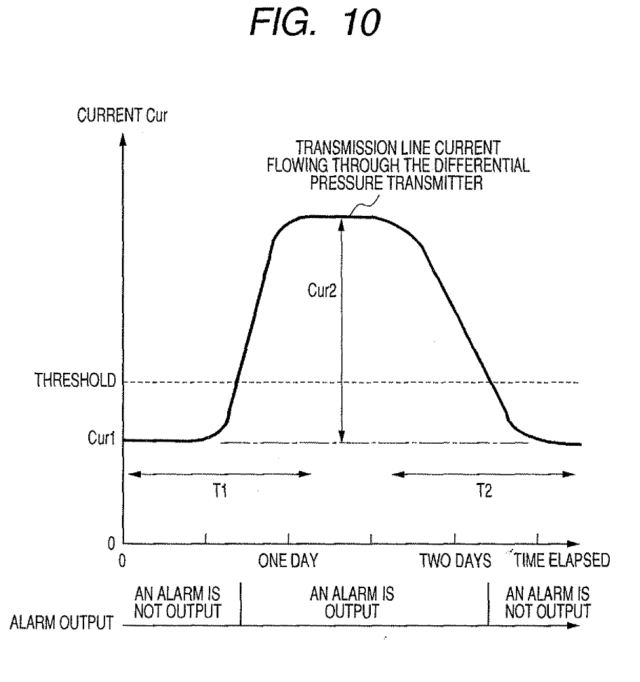

Also, an example of a change of currents of the transmission lines 7,8 fed to the differential pressure transmitter 9 to a time when a terminal portion of the differential pressure transmitter 9 is submerged is shown in FIG. 10. A Cur 1 denotes an electric current (about 15 mA) flowing through the differential pressure transmitter 9 when the transmission line is in a normal condition. A Cur 2 denotes a leakage current flowing through the terminals when the terminal portion is submerged.

When the terminal portion of the differential pressure transmitter 9 is submerged, the leakage current Cur 2 goes up to 30 m A while consuming several times to about one day (T1). Then, when a corrosion of the terminal portions starts, flow of the leakage current Cur 2 stops after several days has elapsed (T2). The alarm outputting portion output the alarm if the measured value is larger than the threshold, while the alarm outputting portion does not output the alarm if the measured value is smaller than the threshold.

In the present embodiment, when the terminal portion of the differential pressure transmitter 9 is submerged, the diagnostic module 20 detects an increase of the transmission line current caused due to an increase of the leakage current flowing through the terminal portions, and detects failure of the transmission line caused due to a reduction of the output voltage of the DC power supply 3 or a superposition of the noise. Then, the diagnostic module 20 outputs the alarm to notify the user that the failure is present, and calls upon the user to remove or exchange the field device acting as the cause of failure. As a result, the field device system that is able to prevent occurrence of the communication interference, prevent generation of a dangerous gas such as hydrogen, or the like, go on control of a physical quantity, and improve reliability can be realized.

### Second Embodiment

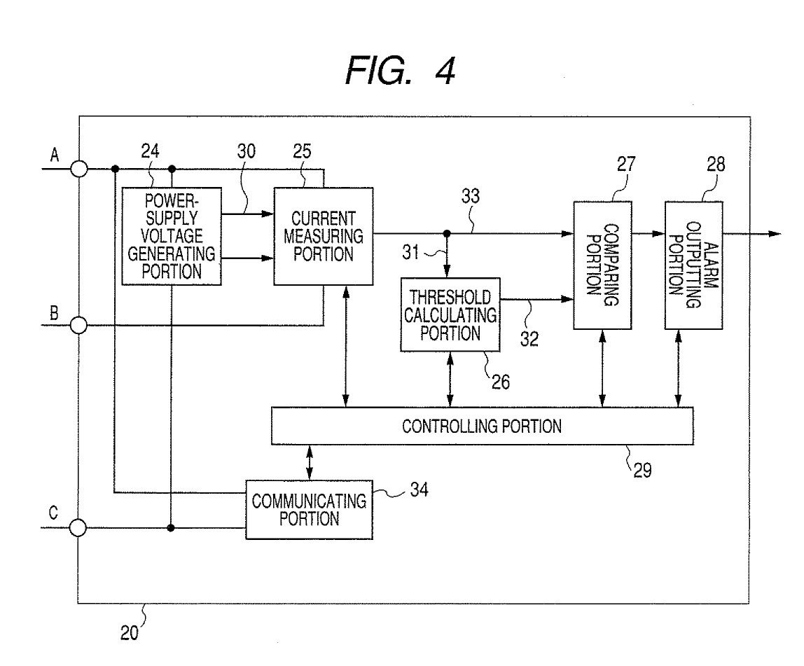

A second embodiment of the diagnostic module 20 shown in a block diagram will be explained with reference to FIG. 4 hereunder. In FIG. 4, the same symbols are affixed to the same elements as those in FIG. 3 and their explanation will be omitted herein.

In FIG. 4, a communicating portion 34 is connected to the terminal A and the terminal C and the controlling portion 29. The communicating portion 34 receives the communication signal for calling upon the diagnostic module 20 to send the information from the host unit 6 via the transmission lines 1, 2, and transmits the information to the host unit 6 via the controlling portion 29. As the information, there are the output of the controlling portion 29, the measured value 33 of the current measuring portion 25, and the like. For example, data “1” is transmitted as the alarm output when the abnormality occurs in the transmission line (step S7), while data “0” is transmitted as the information when no abnormality occurs in the transmission line (step S9). In this case, the communicating portion 34 may also make the operation of the controlling portion 29, and may acquire the information from the output of the alarm outputting portion 28 or the output of the current measuring portion 25 without the intervention of the controlling portion 29.

According to the present embodiment, the user cam monitor whether or not the abnormality occurs in the transmission line, in a concentrated manner via the host unit 6 in a control room where the host unit 6 is installed. Therefore, the field device acting as the cause of the failure can be removed or exchanged quickly. As a result, the field device system that is able to prevent occurrence of the communication interference, prevent generation of a dangerous gas such as hydrogen, or the like, go on control of a physical quantity, and improve reliability can be realized.

### Third Embodiment

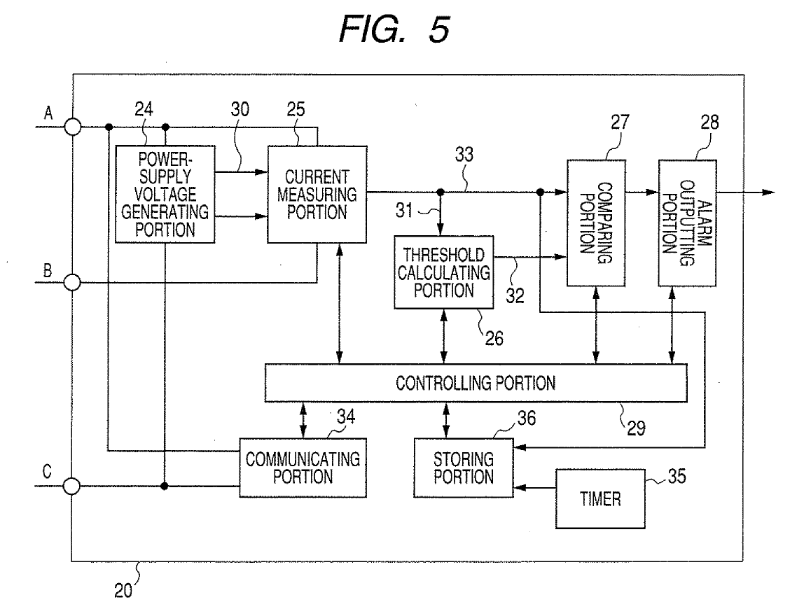

A third embodiment of the diagnostic module 20 shown in a block diagram will be explained with reference to FIG. 5. In FIG. 5, the same symbols are affixed to the same elements as those in FIGS. 3, 4 and their explanation will be omitted herein.

In FIG. 5, the diagnostic module 20 has a timer 35 and a storing portion 36. The timer 35 contains time information of current date and time. The storing portion 36 is connected to the output of the current measuring portion 25, the output of the timer 35, and the controlling portion 29.

The storing portion 36 stores the time information of the timer 35 and the measured value 33 of the current measuring portion 25, as the information that the diagnostic module 20 has. For example, the data is stored in the storing portion 36 between step S5 and step S6 in FIG. 9. The alarm output data may be stored in the storing portion 36 via the controlling portion 29 in step S7 and step S9.

In response to the information requesting signal from the host unit 6, the communicating portion 34 sends the time information, the measured value, and alarm output data from the storing portion 36 to the host unit 6 via the controlling portion 29. In this case, the communicating portion 34 may also take the operation of the controlling portion 29, and may acquire the information from the output of the storing portion 36 without the intervention of the controlling portion 29.

According to the present embodiment, the measured value 33 can be monitored in time-series, and the field device acting as the cause of failure can be removed or exchanged before the alarm output notifying that the abnormality occurs in the transmission line is issued when the measured value 33 is increased gradually. As a result, the field device system that is able to prevent in advance occurrence of the communication interference and generation of a dangerous gas such as hydrogen, or the like, go on control of a physical quantity, and improve reliability can be realized.

### Fourth Embodiment

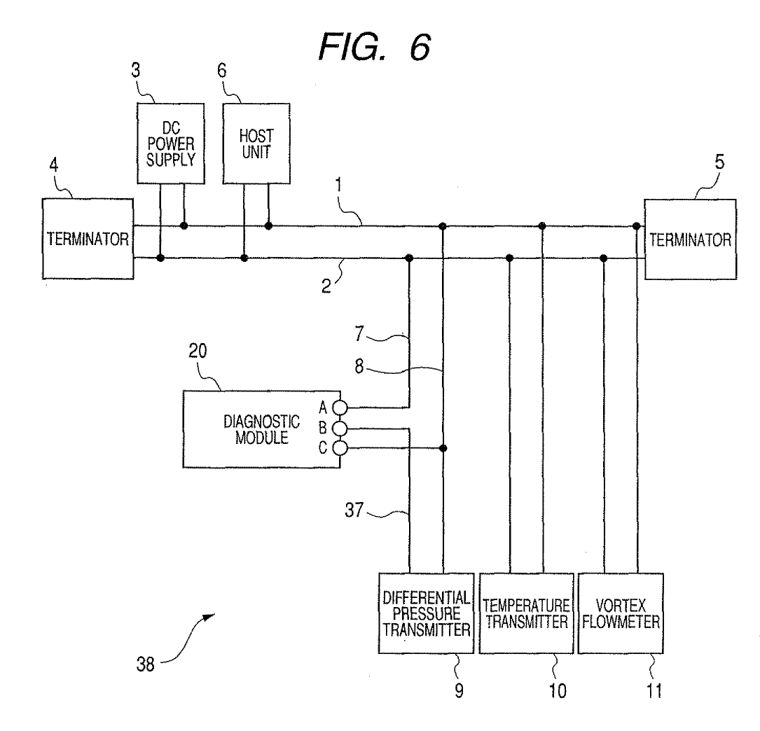

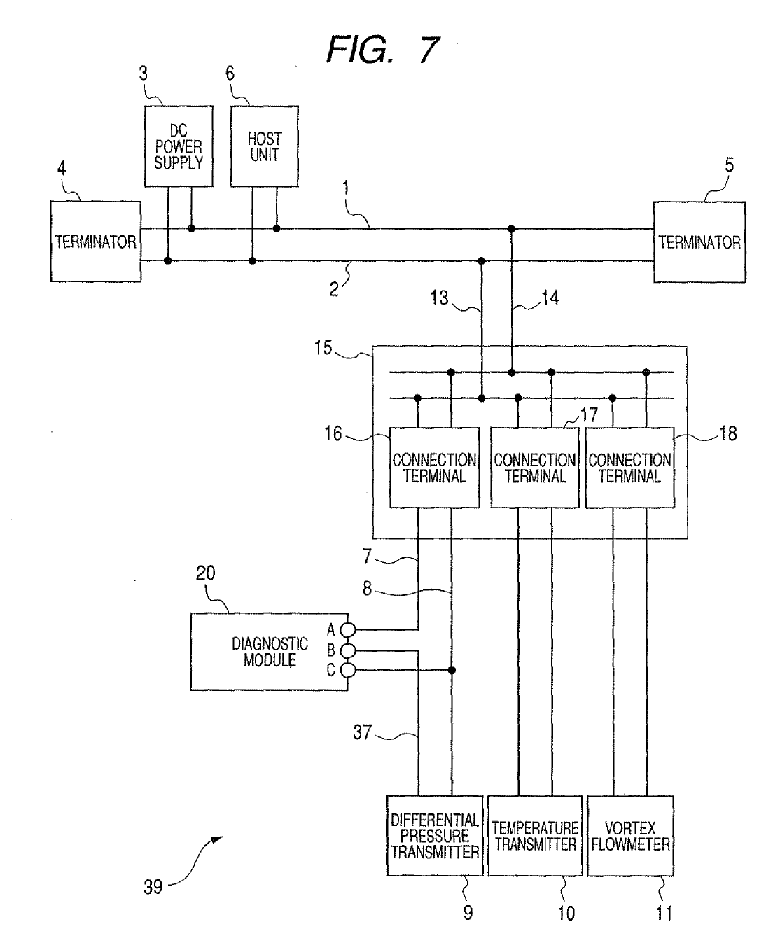

A fourth embodiment in which connection locations of the diagnostic module 20 and the transmission line are set differently from those in FIG. 1 and FIG. 2 will be explained with reference to FIG. 6 and FIG. 7 hereunder. FIG. 6 is a field device system showing an embodiment in which the diagnostic module 20 is connected to the transmission lines 7, 8. FIG. 7 is a field device system in which the multiple device connecting device 15 is employed in FIG. 6, and the same symbols are affixed to the same elements as those in FIG. 1 and FIG. 2 and their explanation will be omitted herein.

In more detail, the terminal A of the diagnostic module 20 is connected to the transmission line 7, the terminal B thereof is connected to a transmission line 37, and the terminal C thereof is connected to the transmission line 8.

In the first to third embodiments, the diagnostic module 20 measures the transmission line current flowing through a plurality of field devices such as the differential pressure transmitter 9, and the like. In contrast, in the present embodiment, the diagnostic module 20 measures the transmission line current flowing through one field device such as the differential pressure transmitter 9, or the like. For this purpose, the threshold calculating portion 26 calculates or sets the threshold 32 to detect the failure of the transmission lines 7, 37, 8 caused by the leakage current that flows through the terminal portions of one field device system.

According to the present embodiment, when the alarm outputting portion 28 outputs the alarm output indicating that the abnormality occurs in the transmission line, the field device system acting as the cause of the failure can be specified. Thus, this field device can be removed or exchanged more quickly. As a result, the field device system that is able to prevent occurrence of the communication interference, prevent generation of a dangerous gas such as hydrogen, or the like, go on control of a physical quantity, and improve reliability can be realized.

### Fifth Embodiment

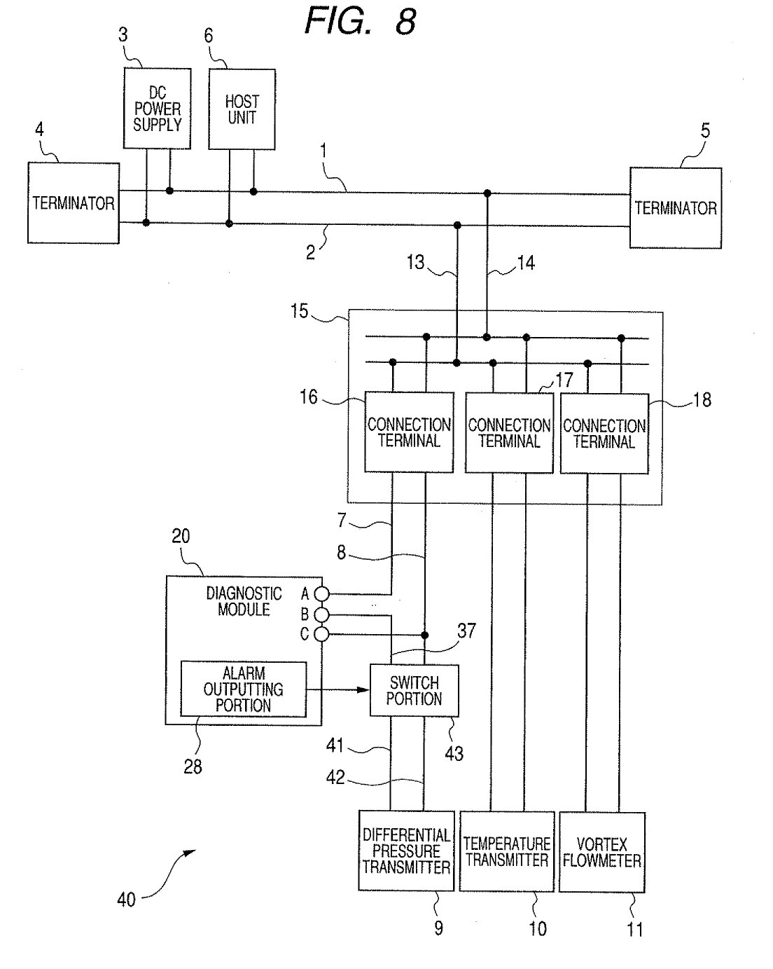

A fifth embodiment in which a switching portion 43 is provided to the configuration in FIG. 7 will be explained with reference to FIG. 8 hereunder. The switching portion 43 is connected between the transmission lines 37, 8 and the field device such as the differential pressure transmitter 9, or the like.

More specifically, the terminal A of the diagnostic module 20 is connected to the transmission line 7, the terminal B thereof is connected to the transmission line 37, and the terminal C thereof is connected to the transmission line 8. A switch portion 43 is connected to the transmission lines 37, 8 and an output of an alarm outputting portion 28 of the diagnostic module 20, and is connected to the differential pressure transmitter 9 via transmission lines 41, 42.

In step S9 in FIG. 9, the switch portion 43 connects the transmission line 37, 8 and the transmission lines 41, 42 based on the alarm output of the alarm outputting portion 28 indicating that no abnormality occurs in the transmission line. Also, in step S7, the switch portion 43 disconnects the transmission lines 37, 8 and the transmission lines 41, 42 based on the alarm output of the alarm outputting portion 28 indicating that the abnormality occurs in the transmission line. Then, the alarm outputting portion 28 keeps the output having the failure, and the switch portion 43 keeps the condition that the transmission lines 37, 8 and the transmission lines 41, 42 are disconnected, based on the output of the alarm outputting portion 28. In this case, the switch portion 43 may be connected in series with the current measuring portion 25 of the diagnostic module 20 and the terminal B. Also, an embodiment in which the switch portion 43 is provided similarly to the configuration in FIG. 6.

According to the present embodiment, when the alarm outputting portion 28 outputs the alarm output indicating that the abnormality occurs in the transmission line, the field device acting as the cause of the failure is disconnected automatically from the connected transmission line, and thus a manual labor can be reduced. As a result, the field device system that is able to prevent more quickly occurrence of the communication interference, prevent generation of a dangerous gas such as hydrogen, or the like, go on control of a physical quantity, and improve reliability can be realized.

Here, the present invention can be applied to the failures of the transmission line such as the short circuit, and the like caused not only by the submergence of the terminal portions of the field device but also by the submergence of the connection terminals 16, 17, 18 of the multiple device connecting device 15 by the rainwater, the degradation of the transmission line, or the like. Also, the diagnostic module 20 may be provided in the multiple device connecting device 15.

### Sixth Embodiment

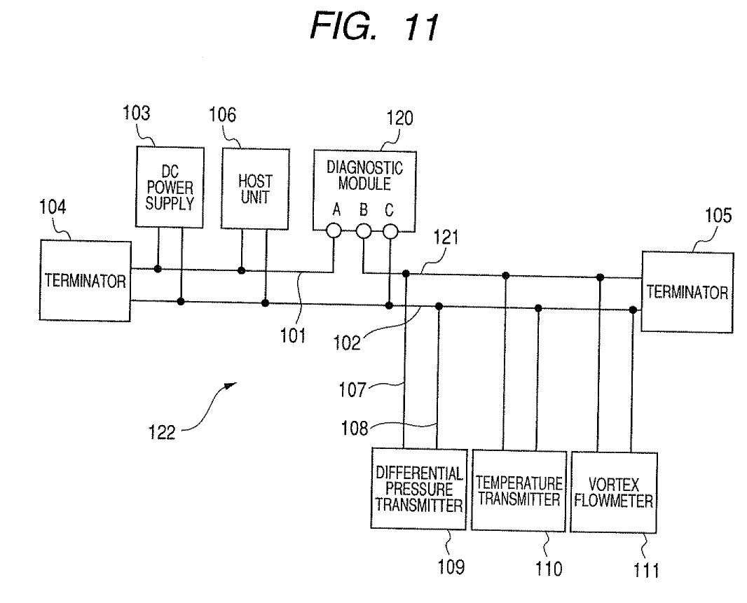

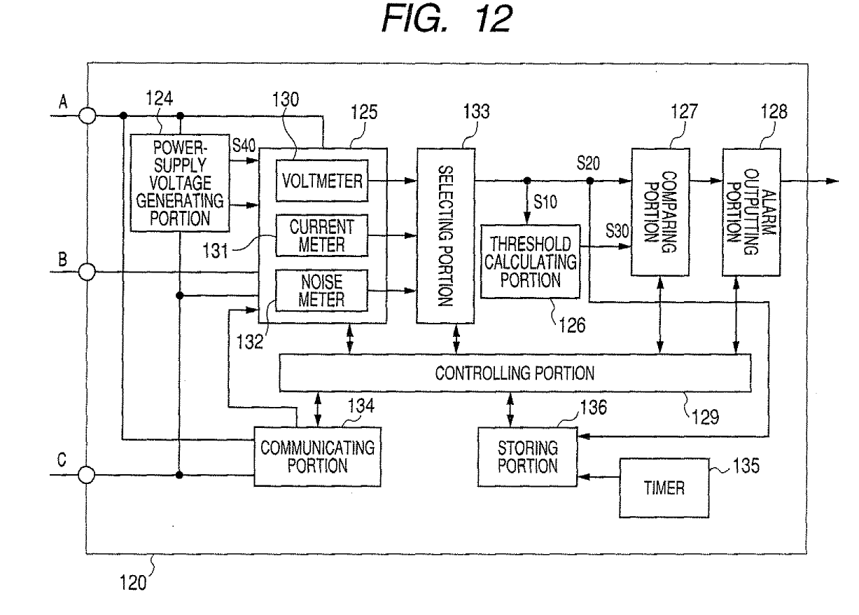

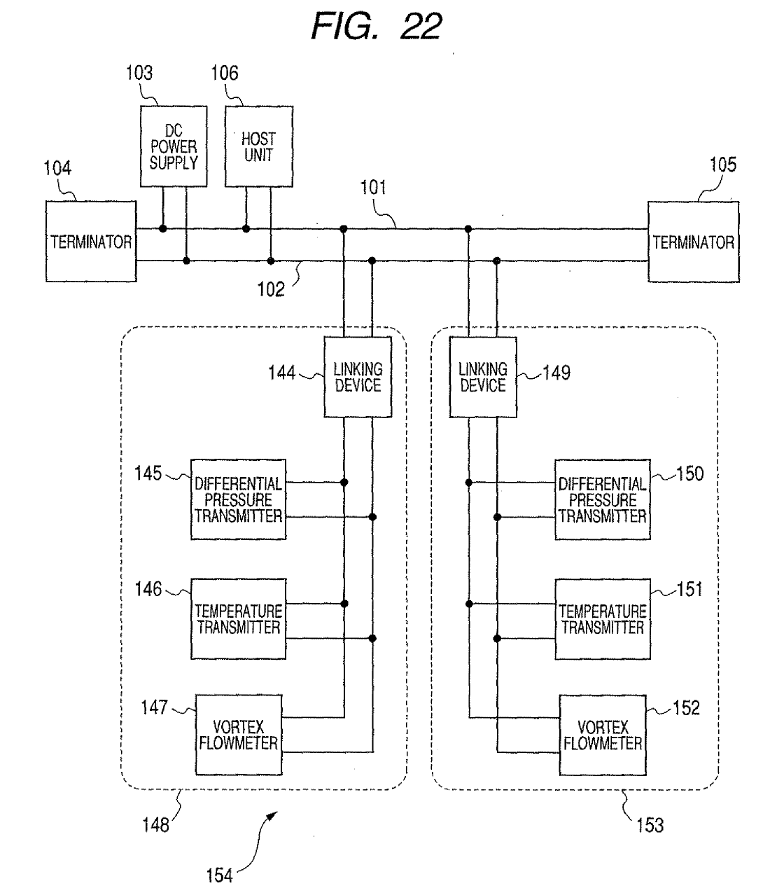

A sixth embodiment will be explained with reference to FIG. 11 and FIG. 12 hereunder. FIG. 11 is a field device system 122 showing the sixth embodiment of the present invention, the same symbols are affixed to the same elements as those in FIG. 22 and their explanation will be omitted herein. FIG. 12 is a block diagram of a diagnostic module 120.

In FIG. 11, the diagnostic module 120 is connected to the transmission lines 101, 121, 102 between the DC power supply 103 and a plurality of field devices 109, 110, 111.

More specifically, a terminator A of the diagnostic module 120 is connected to the transmission line 101, a terminal B thereof is connected to a transmission line 121, and a terminal C thereof is connected to the transmission line 102. A terminator 105 is connected to the transmission lines 121, 102, and a differential pressure transmitter 109 as one of field devices is connected to transmission lines 107, 108 branched off from the transmission lines 121, 102. Similarly, a temperature transmitter 110 and a vortex flowmeter 111 are connected to the transmission lines branched off from the transmission lines 121, 102.

In FIG. 12, the diagnostic module 120 is composed of a power-supply voltage generating portion 124, a measuring portion 125, a selecting portion 133, a threshold calculating portion 126, a comparing portion 127, an alarm outputting portion 128, a controlling portion 129, a communicating portion 134, a timer 135, and a storing portion 136.

The power-supply voltage generating portion 124 is connected to the terminal A and the terminal C, and generates a internal power-supply voltage S40 from an output voltage of the DC power supply 103. Then, the power-supply voltage generating portion 124 supplies this voltage to respective portions such as a measuring portion 125, and the like.

The measuring portion 125 is connected to terminals A, B, C, an output of the communicating portion 134, and the like, and consists. of instruments such as a voltmeter 130, a current meter 131, a noise meter 132, etc. for measuring electric characteristics of the transmission lines 101, 121, 102. A resistance meter, a capacitance meter, an oscilloscope (not shown), etc. are contained in the measuring portion.

The voltmeter 130 measures a DC voltage across the transmission lines 101, 102 via the terminals A, C, and measures a peak-to-peak voltage in a communication waveform out of the output of the communicating portion 134. The current meter 131 is connected between the terminals A, B and measures a transmission line current flowing through the transmission lines 101, 121, 102 containing the current flowing through the differential pressure transmitter 109. The noise meter 132 measures a noise level on the transmission line 101. The resistance meter and the capacitance meter measure a resistance and a capacitance between the transmission lines 101, 102. The oscilloscope measures a voltage waveform between the transmission lines 101, 102, a communication waveform of the output of the communicating portion 134, and others.

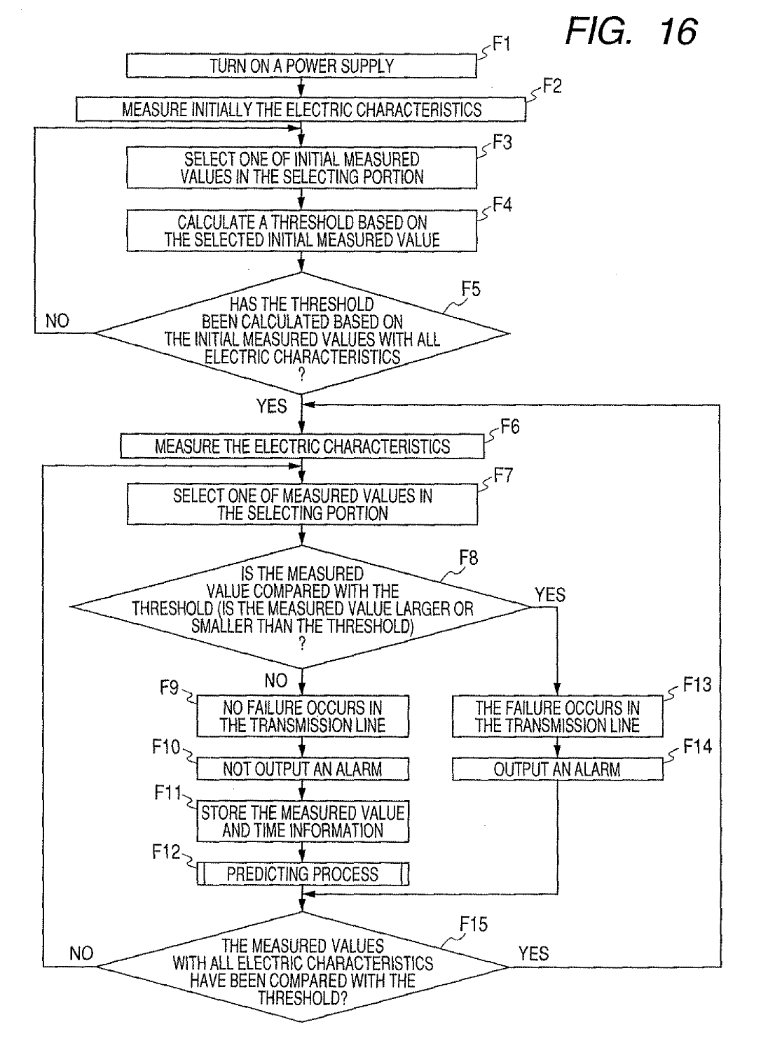

The selecting portion 133 is connected to the outputs of the voltmeter 130, etc. constituting the selecting portion 125. The selecting portion 133 selects one of the measured values measured by the voltmeter 130, etc. based on a switching signal output from the controlling portion 129, and outputs the value. In this case, the controlling portion 129 can be implemented by causing a microprocessor (not shown) to execute operations in a flowchart in FIG. 16 in compliance with a computer program (not shown).

The threshold calculating portion 126 calculates a threshold S30 based on an initial measured value S10 selected by the selecting portion 133, and outputs the threshold. The comparing portion 127 compares the threshold S30 and a measured value S20 selected by the selecting portion 133. The alarm outputting portion 128 outputs the alarm based on the output of the comparing portion 127. The output of the alarm outputting portion 128 is connected to the acoustic device such as the buzzer, or the like or the illumination device such as the lamp, or the like (not shown). In this case, the selecting portion is not provided, but the configuration equipped with a plurality of threshold calculating portions, the comparing portion, and the alarm outputting portion connected to outputs of the voltmeter 130, the current meter 131, and the noise meter 132 respectively.

The timer 135 has time information consisting of current date and time. The storing portion 136 is connected to the output of the selecting portion 133, the output of the timer 135, and the controlling portion 129.

The storing portion 136 stores the measured value together with the time information. Also, the storing portion 136 may store the data “1” when the alarm is output, and may store the data “0” when the alarm is not output.

The communicating portion 134 is connected to the terminals A, C and the controlling portion 129. The communicating portion 134 receives the communication signal for requesting the information that the diagnostic module 120 has from a host unit 106 as the external unit via the transmission lines 101, 102. Then, the controlling portion 129 receives the information from the storing portion 136 based on the received signal, and the communicating portion 134 transmits the information to the host unit 6. The information are the time information and the measured value stored in the storing portion 136, and also may contain data of the alarm data.

Here, the selecting portion 133, the threshold calculating portion 126, the comparing portion 127, the alarm outputting portion 128, the controlling portion 129, the timer 135, and the communicating portion 134 can be implemented by causing a microprocessor to execute operations in a flowchart in FIG. 16 in compliance with a computer program.

An operation of the diagnostic module 120 including the diagnosing method will be explained with reference to a flowchart in FIG. 16 hereunder.

When the DC power supply 3 outputs a voltage, a voltage is applied to the terminals A and C of the diagnostic module 120 (step F1). Then, the diagnostic module 120 executes step F2 et seq.

The voltmeter 130, the current meter 131, the noise meter 132, and the like constituting the measuring portion 125 executes the initial measurement of the electric characteristics of the transmission lines 101, 121, 102 (step F2). The selecting portion 133 selects one of initial measured values (step F3).

The selecting portion 133 inputs the selected initial measured value S10 into the threshold calculating portion 126, and the threshold calculating portion 126 calculate the threshold by adding or subtracting a variation to or from the selected initial measured value (step F4). In this case, the threshold S30 may be varied and set.

Then, step F3 et seq. are repeated unless the threshold S30 has been calculated based on the initial measured values S10 with all electric characteristics, or step F6 et seq. are executed if the threshold S30 has been calculated based on the initial measured values (step F5).

The voltmeter 130, the current meter 131, the noise meter 132, and the like constituting the measuring portion 125 measure the electric characteristics of the transmission lines 101, 121, 102 (step F6). The selecting portion 133 selects one of measured values (step F7).

The comparing portion 127 compares the selected measured value S20 with the threshold S30 (step F8). If the measured value S20 is larger or smaller than the threshold S30, the comparing portion 127 detects that the abnormality occurred in the transmission line (step F13). The alarm outputting portion 128 outputs an alarm (e.g., a voltage signal of about 5 volt) based on the output of the comparing portion 127 (step F14). Thus, the user can know that the abnormality occurred in the transmission line by the sound or the light emitted from the buzzer or the lamp connected to the output of the alarm outputting portion 128.

For example, the threshold of the DC voltage between the transmission lines 101, 102 is 20.8 volt and 21.2 volt. If the measured value S20 is smaller than 20.8 volt or larger than 21.2 volt, the alarm outputting portion 128 outputs the alarm (step F14). Similarly, the threshold of the peak-to-peak voltage of the communication waveform is 0.8 volt and 1.2 volt.

In contrast, if the measured value S20 is neither larger than the threshold S30 nor smaller than the threshold S30 (for example, the DC voltage is in a range from 20.8 volt to 21.2 volt), the comparing portion 127 detects that no abnormality occurred in the transmission line (step F9). Thus, the alarm outputting portion 128 does not output the alarm (step F10). The storing portion 136 stores the measured value S20 and the time information of the timer 135 (step F11).

After the process in step F11 or step F14 is executed, the process goes to step F15 (the predicting process (step F12) will be described later). In this case, the storing portion 136 may store the data (“1” or “0”) of the alarm output before the process in step F15 is executed.

Step F7 et seq. are repeated unless the measured values S20 with all electric characteristics have been compared with the threshold S30, and step F6 et seq. are repeated if the measured values S20 have been compared with the threshold S30 (step F15). The comparison with the threshold S30, the failure diagnosis of the transmission line, the storing, and the like of the measured values S20 of all electric characteristics are carried out by these processes.

The communication process between the host unit 6 and the diagnostic module 120 (not shown in FIG. 16) sends the information stored in the storing portion 136 to the host unit 6 via the communicating portion 134, based on the periodical or non-periodical communication signal from the host unit 6.

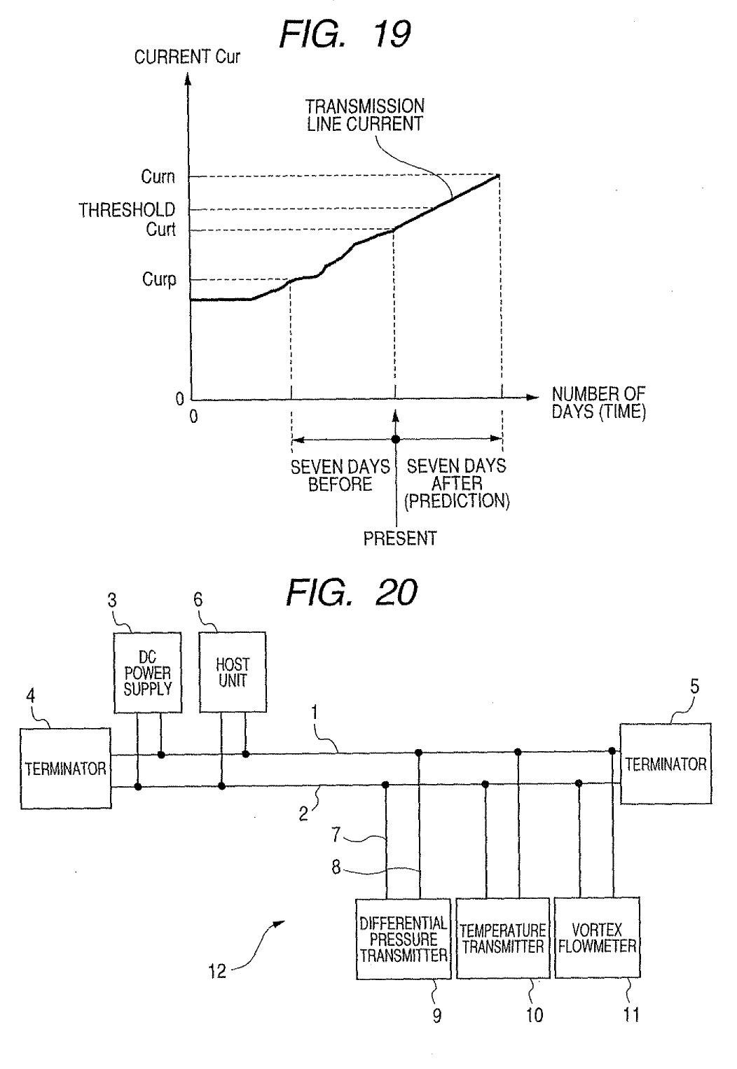

In FIG. 19, the situation that, when the transmission line absorbs a moisture due to the influence of the surrounding environment, for example, in the high humidity environment, the insulation degradation of the transmission lines 107, 108 connected to the differential pressure transmitter 9 proceeds and the current flowing through the transmission line is increased gradually will be explained hereunder.

For example, the transmission line current measured by the current meter 131 at seven days before from now was Curp, but the transmission line current is increased gradually because of the progress of the insulation degradation and the current becomes Curt at present. At present, the failure of the transmission line is not diagnosed since the current is smaller than the threshold. But the user can predict that the transmission line current becomes larger than the threshold within seven days after from now and the failure of the transmission line is diagnosed when such user checks the time information and the transmission line current fed from the diagnostic module 120 at the host unit 106.

Then, the user investigates the insulation degradation of the transmission lines 107, 108 based on the above prediction before the failure of the transmission line occurs and the communication interference is caused. Then, when the user finds that the resistance of the transmission lines is small, such user can prevent occurrence of the communication interference by exchanging the transmission line. As a result, reliability of communication, etc. of the field device system can be improved.

According to the present embodiment, the user can predict in advance particularly generation of the failure such as open circuit, short circuit, or the like of the transmission line in the failure diagnosis of the field device system, prevent the occurrence of the communication interference, and improve reliability of measurement, communication, control, etc. in the field device system.

### Seventh Embodiment

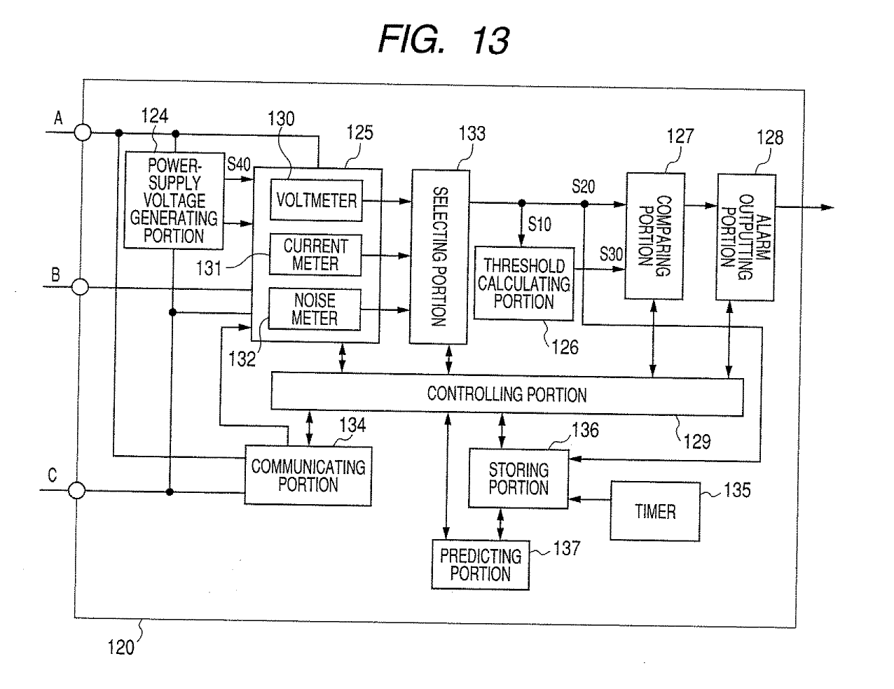

A seventh embodiment will be explained with reference to FIG. 13 hereunder. FIG. 13 is a block diagram of the diagnostic module 120, and the same symbols are affixed to the same elements as those in FIG. 12 and their explanation will be omitted herein.

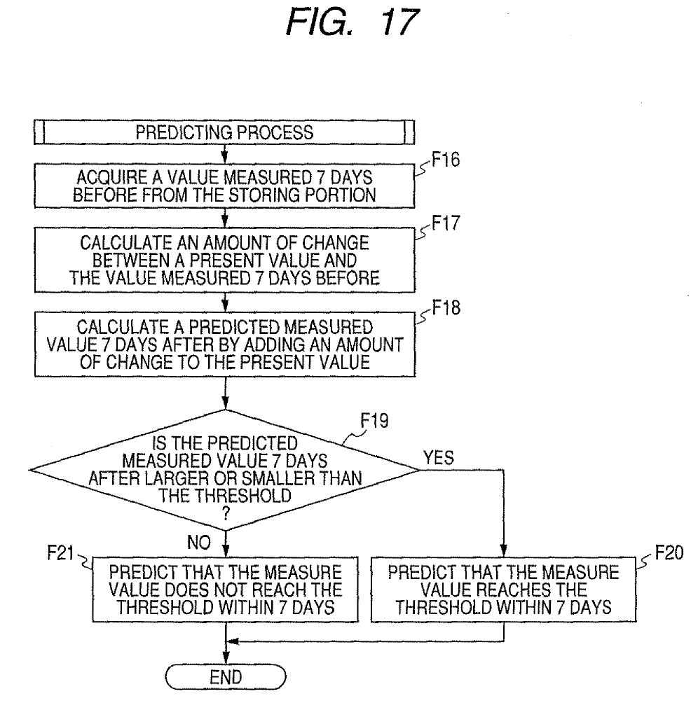

In FIG. 13, a predicting portion 137 is connected to the storing portion 136 and the controlling portion 129. This predicting portion 137 gets the measured value measured predetermined days before from now from the storing portion 136, and predicts whether or not the measured value at present reaches the threshold after a predetermined time has elapsed. The diagnostic module 120 transmits the predicted result to the host unit 106 via the controlling portion 129 and the communicating portion 134, based on the communication signal from the host unit 106. In this case, the predicting portion 137 can be implemented by causing a microprocessor to execute operations in a flowchart in FIG. 17 in compliance with a computer program.

An operation of the predicting portion 137 including the diagnosing method will be explained with reference to a flowchart in FIG. 17 and FIG. 19 hereunder. As described above, FIG. 19 shows a situation that the insulation degradation occurs in the transmission lines 107, 108.

The predicting process executed in step F12 in FIG. 16 predicts the transmission line current after 7 days from now in the situation that, for example, the transmission line current measured 7 days before from now was Curp and the transmission line current is increased up to Curt at present.

The predicting portion 137 acquires the measure value Curp of the transmission line current measured 7 days before from now from the storing portion 136, based on the time information (step F16). Then, the predicting portion 137 calculates an amount of change ΔCur(=Curt−Curp) between a present value and the value measured 7 days before (step F17).

Then, the predicting portion 137 calculates a predicted measured value Curn after 7 days by adding an amount of change ΔCur to the present measured value Curt (step F18). If the predicted measured value Curn is larger than the threshold (step F19), the predicting portion 137 predicts that the measure value reaches the threshold within 7 days (step F20). In contrast, if the predicted measured value Curn is smaller than the threshold (step F19), the predicting portion 137 predicts that the measure value does not reach the threshold within 7 days (step F21).

The diagnostic module 120 transmits the predicted result to the host unit 106 via the communicating portion 134, based on the communication signal from the host unit 106.

The user knows that the failure of the transmission line will occur in future and the communication interference will be caused, from the predicted result at the host unit 106. Then, when the user investigates the insulation resistance of the transmission lines 107, 108 prior to such occurrence and knows that the insulation resistance is reduced, such user can prevent the occurrence of the communication interference by exchanging the transmission line. As a result, reliability in communication, etc. of the field device system can be improved.

According to the present embodiment, the user can get particularly the predicted result showing that the failure such as open circuit, short circuit, or the like of the transmission line will be generated in the failure diagnosis of the field device system, prevent the occurrence of the communication interference, and improve reliability of measurement, communication, control, etc. in the field device system. Also, a monitoring load of the measured value of the user can be lessened because the diagnostic module 120 executes the above prediction.

### Eighth Embodiment

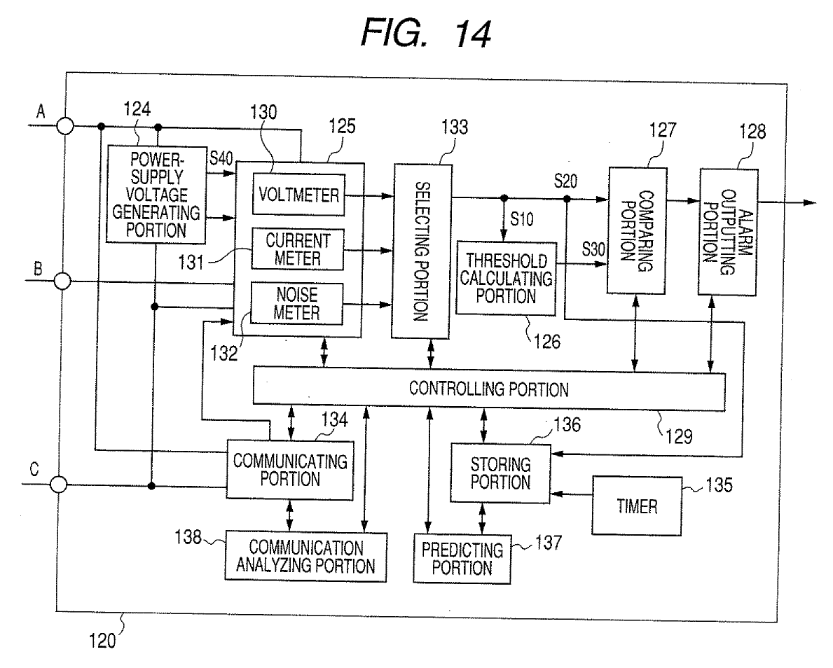

An eighth embodiment will be explained with reference to FIG. 14 hereunder. FIG. 14 is a block diagram of the diagnostic module 120, and the same symbols are affixed to the same elements as those in FIGS. 12, 13 and their explanation will be omitted herein. Normally, the host unit 106 sends a communication signal to a particular field device and receives a response signal from the field device.

In FIG. 14, a communication analyzing portion 138 is connected to the communicating portion 134 and the controlling portion 129. The communication analyzing portion 138 acquires the communication signal concerning the particular field device from the host unit 106 via the communicating portion 134, and calculates the number of times and a rate of the communication error caused when the field device does not respond to the communication signal.

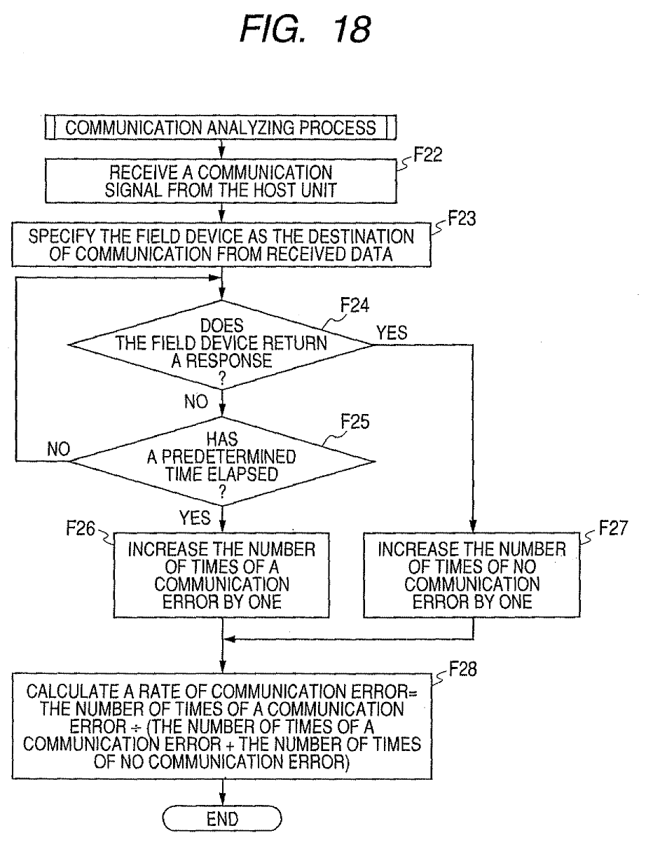

Then, the diagnostic module 120 transmits the number of times and the rate of the communication error to the host unit 106 via the controlling portion 129 and the communicating portion 134, in response to the communication signal from the host unit 106. In this case, the predicting portion 137 can be implemented by causing a microprocessor to execute operations in a flowchart in FIG. 18 in compliance with a computer program.

An operation of the communication analyzing portion 138 including the diagnosing method will be explained with reference to a flowchart in FIG. 18 hereunder. The process in FIG. 18 is executed when the diagnostic module 120 receives the communication signal from the host unit 106.

The communicating portion 134 receives the communication signal concerning the particular field device from the host unit 106 (step F22). The communication analyzing portion 138 gets the received signal from the communicating portion 134, and specifies the field device as the destination of communication by examining the destination address contained in the communication (step F23).

Then, the communication analyzing portion 138 whether or not the destination field device returns a response signal (step F24). If the response signal is returned, the communication analyzing portion 138 increases the number of times of no communication error in the field device by one (step F27). Then, the process in step F28 is executed. In contrast, if the response signal is not returned and it is decided that a predetermined time (e.g., 1 minute) has not elapsed (step F25), the process in step F24 is repeated. Also, if a predetermined time has elapsed, the communication analyzing portion 138 increases the number of times of a communication error of the field device by one (step F26). Then, the communication analyzing portion 138 calculates a rate of the communication error of the field device by dividing the number of times of the communication error by the total number of times of the communication error and the number of times of no communication error (step F28).

Then, the diagnostic module 120 transmits the identification number of each field device, the number of the communication error, and the rate of the communication error to the host unit 106 via the communicating portion 134, based on the communication signal from the host unit 106.

When the characteristics of the components of the communication circuit in the field device are degraded, the response signal is not returned from the field device, and the communication interference is caused frequently, the user can know that the number of time and the rate of the communication error are large at the host unit 106 and can know the particular field device as the cause of the communication interference by referring to the identification number. Therefore, occurrence of the communication interference can be suppressed by exchanging the field device in the small number of man-hours needed to investigate the cause, and reliability of communication, etc. of the field device system.

According to the present embodiment, the user can get particularly the information about the communication error of the field device in the failure diagnosis of the field, and therefore can suppress the occurrence of the communication interference, and improve reliability of measurement, communication, control, etc. in the field device system. Also, the user can lessen a burden in investigating the cause of the communication interference.

### Ninth Embodiment

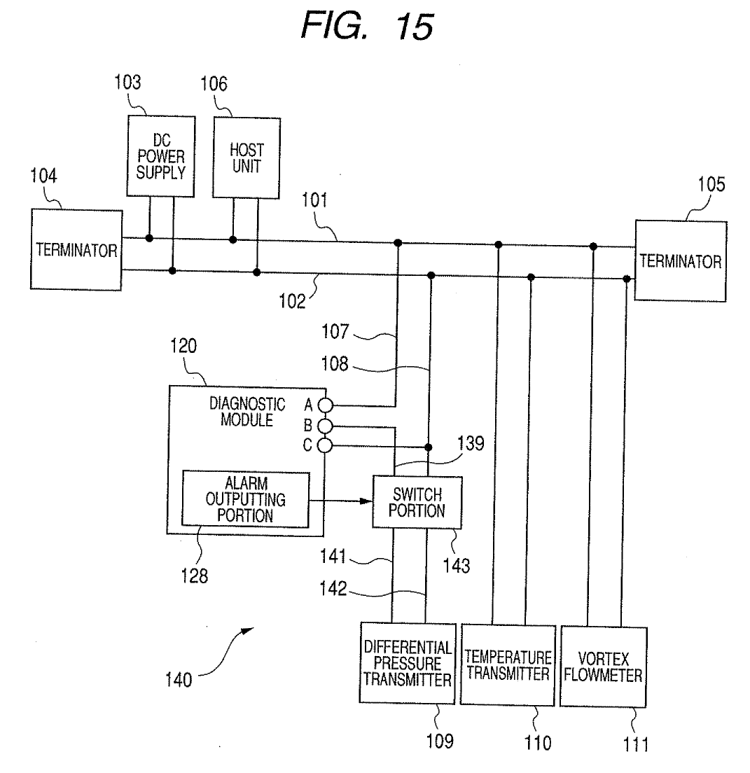

A ninth embodiment in which connection locations of the diagnostic module 120 and the transmission line are set differently from FIG. 11 and the switching portion is provided further will be explained with reference to FIG. 15 hereunder. In FIG. 15, the same symbols are affixed to the same elements as those in FIG. 11 and their explanation will be omitted herein.

More specifically, the terminal A of the diagnostic module 120 is connected to the transmission line 107, the terminal B thereof is connected to a transmission line 139, and the terminal C thereof is connected to the transmission line 108. A switch portion 143 is connected to the transmission lines 139, 108 and an output of an alarm outputting portion 128 of the diagnostic module 120, and is connected to the differential pressure transmitter 109 via transmission lines 141, 142.

In step F9 in FIG. 16, the diagnostic module 120 detects that no failure occurred in the transmission line, and the switch portion 143 connects the transmission lines 139, 108 and the transmission lines 141, 142 based on the output (e.g., the voltage signal of about 0 volt) of the alarm outputting portion 128. Also, the diagnostic module 120 detects that no failure occurred in the transmission line (step F13), and the switch portion 143 disconnects the transmission lines 139, 108 and the transmission lines 141, 142 based on the output (e.g., the voltage signal of about 5 volt) of the alarm outputting portion 128. Subsequently, the alarm outputting portion 128 keeps its output, and the switch portion 143 keeps the state that the transmission lines 139, 108 and the transmission lines 141, 142 are disconnected. In this case, the switch portion. 143 may be connected in series between the terminals A, B in the diagnostic module 120.

For example, the transmission line is short-circuited inadvertently at the terminal portions (not shown) of the differential pressure transmitter 109 connected to the transmission lines. At this time, because the current that is larger than the threshold flows through the transmission lines 107, 141, 142, 108, the diagnostic module 120 detects in step F13 in FIG. 16 that the failure occurred in the transmission line. The switch portion 143 can remove the short-circuited transmission line by disconnecting the transmission lines 139, 108 and the transmission lines 141, 142 based on the output of the alarm outputting portion 128. Therefore, the field device system 140 can establish the communication again.

According to the present embodiment, the diagnostic module 120 and the switch portion 143 can prevent occurrence of the communication interference by disconnecting automatically the transmission line acting as the cause of the failure of the transmission line, and can improve reliability in measurement, communication, control, etc. of the field device system. Also, a user's burden in investigating the cause at a time of occurrence of the communication interference and recovering the communication can be reduced.

In this case, the diagnostic module 120 or the diagnosing method of the present invention may be provided to the inside of the field device such as the host unit 106, the differential pressure transmitter 109, or the like, or the mobile device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A field device system comprising:
a transmission line; and
a diagnostic module for detecting whether or not a failure of the transmission line is present.

2. A field device system according to claim 1, wherein the diagnostic module has
a current measuring portion for measuring a current flowing through the transmission line,
a threshold calculating portion for calculating a threshold based on an initial measured value of the current measuring portion,
a comparing portion for comparing a measured value of the current measuring portion with the threshold, and
an alarm outputting portion for outputting an alarm based on an output of the comparing portion.

3. A field device system according to claim 2, wherein the diagnostic module further has
a communicating portion for communicating information that the diagnostic module has.

4. A field device system according to claim 2, wherein the diagnostic module further has
a storing portion for storing the measured value of the current measuring portion together with time information.

5. A field device system according to claim 2, wherein the diagnostic module is connected to the transmission line to which the field device is connected.

6. A field device system according to claim 5, further comprising:
a switching portion for connecting or disconnecting the transmission line based on an alarm output of the diagnostic module.

7. A field device system according to claim 1, wherein the diagnostic module has
at least one measuring portion for measuring electric characteristics of the transmission line,
a threshold calculating portion for calculating a threshold based on an initial measured value of the measuring portion,
a comparing portion for comparing a measured value of the measuring portion with the threshold,
an alarm outputting portion for outputting an alarm based on an output of the comparing portion,
a storing portion for storing the measured value of the measuring portion together with time information, and
a communicating portion for holding communication with an external device.

8. A field device system according to claim 7, wherein the diagnostic module further has
a predicting portion for predicting that a present measured value reaches the threshold after a predetermined time has elapsed, based on the measured value stored in the storing portion in a past and time information.

9. A field device system according to claim 7, wherein the diagnostic module further has
a communication analyzing portion for calculating a number of time or a rate of a communication error of a field device.

10. A field device system according to claim 7, wherein the diagnostic module is connected to the transmission line to which one of field devices is connected, and further has
a switching portion for connection or disconnecting the transmission line based on the alarm output.

11. A diagnostic method of detecting a failure of a transmission line of a field device system, comprising:
a step of measuring electric characteristics of the transmission line by a measuring portion;
a step of calculating a threshold based on an initial measured value of the measuring portion;
a step of comparing a measured value of the measuring portion with the threshold;
a step of outputting an alarm based on a compared result;
a step of storing the measured value of the measuring portion together with time information; and
a step of holding communication with an external device.

12. A diagnostic method according to claim 11, further comprising:
a step of predicting that a present measured value reaches the threshold after a predetermined time has elapsed, based on the measured value stored in the storing portion in a past and time information.

13. A diagnostic method according to claim 11, further comprising:
a step of calculating a number of time or a rate of a communication error of a field device.
